(19) United States
(12) Patent Application Publication
(10) Pub. No.: US 2017/0264022 A1
(43) Pub. Date: Sep. 14, 2017

(54) Method to Locate and Identify Artificial Objects in Space Using Van Atta Array Retro-Reflectors and RADAR Systems

(71) Applicant: The United States of America as represented by the Secretary of the Navy, San Diego, CA (US)

(72) Inventors: Austin J Mroczek, San Diego, CA (US); Terence R Albert, San Diego, CA (US)

(21) Appl. No.: 15/064,004

(22) Filed: Mar. 8, 2016

(51) Int. Cl. H01Q 15/14; G01S 13/66; H01Q 1/28

(52) U.S. Cl. CPC H01Q 15/14; H01Q 1/288; G01S 13/66

(57) ABSTRACT

A method to improve the ability to detect, track and identify man-made objects in space, primarily small satellites (Nano-Satellites, Cube Satellites, etc.) in low earth orbit. The method consists of designing and fabricating Van Atta Array retro-reflectors that are designed to match the operating parameters (center frequency, bandwidth, polarization) of RADAR systems that track space objects, and then attaching the retro-reflectors to external surfaces or structures on the small satellites. The retro-reflectors will improve the RADAR cross section of the small satellites, which in turn will improve the ability of the RADAR to detect and track them. Additional enhancements include modulation of the RADAR return, or changing the spectral content or polarization of the RADAR return, to allow unique identification of the small satellite.

### FEDERALLY-SPONSORED RESEARCH AND DEVELOPMENT

The Method to Locate and Identify Artificial Objects in Space Using Van Atta Array Retro-Reflectors and RADAR Systems is assigned to the United States Government and is available for licensing for commercial purposes. Licensing and technical inquiries may be directed to the Office of Research and Technical Applications, Space and Naval Warfare Systems Center, Pacific, Code 72120, San Diego, Calif., 92152; voice (619) 553-5118; email ssc_pac_T2@navy.mil. Reference Navy Case Number 103748.

### BACKGROUND

There are hundreds of thousands of man-made objects in orbit around the Earth. These include active satellites, retired or defunct satellites, rocket bodies, rocket fairings, and debris caused by explosion or collision of such objects. Nanosatellites (nanosats) are an emerging low-cost space technology. They are typically less than a foot long and weigh less than 25 pounds. A common form factor is the Cube Satellite (CubeSat), that can range from 10 centimeters on each side and weigh less than one kilogram to three or six times that size. Nanosats are launched into orbit when a larger satellite mission has spare room, similar to riding on a space-available airlines flight. Once the primary mission separates from the launch vehicle, the nanosats are deployed from a spring-loaded canister. More than 100 were launched in both 2013 and 2014, and hundreds more nanosats are in development. Hundreds of new small, nano, and cube-satellites are being built or planned by a number of organizations.

Various organizations monitor the orbits of objects in space for general space situational awareness, to prevent collision with active satellites, and to protect human life on board the International Space Station. RADAR systems on Earth are generally used to track these space objects. If a surface of an object is not oriented perpendicular to the RADAR when it is being illuminated, the returned signal can be very weak. Many of the small objects, including nanosats and cubesats, do not have a stable orientation which makes it difficult for existing RADAR systems to consistently track and identify them. Active transponder devices have been proposed to improve the ability to track small objects, but these devices require power to operate. If the object to which the transponder is attached loses power, it will not work. A special purpose power supply can be added, but that increases complexity, weight and cost of the system, and it generates heat that must be dissipated.

Described herein is method to improve the ability to detect, track and identify man-made objects in space, primarily the small satellites described above, in low earth orbit. The method consists of designing and fabricating Van Atta Array retro-reflectors that are designed to match the operating parameters (center frequency, bandwidth, polarization) of RADAR systems that track space objects, and then attaching the retro-reflectors to external surfaces or structures on the small satellites. The retro-reflectors will improve the RADAR cross section of the small satellites, which in turn will improve the ability of the RADAR to detect and track them.

### BRIEF DESCRIPTION OF THE DRAWINGS

FIGS. 1A-1D show various embodiments of retro-reflectors having an array of antennas in varying shapes and sizes.

FIG. 2 shows an embodiment of a satellite having deployable antennas and solar panels.

FIG. 3 shows an operational concept graphic demonstrating Van Atta array retro-reflectors attached to a cubesat and tracked using a desired RADAR system.

FIG. 4 shows a RADAR system sending a signal to a satellite without an attached Van Atta array retro-reflector and to a satellite with an attached Van Atta array retro-reflector.

FIG. 5 shows a graph of RADAR return from various experimental retro-reflectors.

FIG. 6 shows the Van Atta array retro-reflector in the Ku-band and in the X-band, respectively.

### DETAILED DESCRIPTION OF SOME EMBODIMENTS

Reference in the specification to “one embodiment” or to “an embodiment” means that a particular element, feature, structure, or characteristic described in connection with the embodiments is included in at least one embodiment. The appearances of the phrases “in one embodiment,” “in some embodiments,” and “in other embodiments” in various places in the specification are not necessarily all referring to the same embodiment or the same set of embodiments.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of the “a” or “an” are employed to describe elements and components of the embodiments herein. This is done merely for convenience and to give a general sense of the invention. This detailed description should be read to include one or at least one and the singular also includes the plural unless it is obviously meant otherwise.

In tracking objects in space, it can be difficult for a RADAR system to receive a return signal from a satellite when the satellite is positioned a few degrees from normal (90 degrees). Van Atta array retro-reflectors provide similar return at normal, but the drop off is much less at angles other than normal. A Van Atta array retro-reflector needs to be designed to match the operating characteristics of a selected RADAR system, such as the bandwidth, frequency, and polarization. The size of the device will depend on the operating frequency of the RADAR and the desired improvement in RADAR return. Next the Van Atta array retro-reflector is fabricated and integrated onto the surface a space object, and then launched into space. The intended RADAR illuminates the space object. Van Atta array retro-reflectors are small enough in the Ku and X-band that they can be integrated into a nano- or cubesat.

The Van Atta array retro-reflector is a two dimensional (flat) object, whereas corner reflectors require three surfaces perpendicular to each other and occupy a three dimensional volume. A flat retro-reflector can be more easily integrated into satellite and space object designs and mounted on external surfaces. A Van Atta array retro-reflector can be designed as a passive device, requiring no power to operate. Current cube- and nano-satellites have no special tracking ability. Some have proposed add-on, active radio frequency devices but they required power from the spacecraft, or batteries for short life operations. Additional enhancements include modulation of the RADAR return, or changing the spectral content or polarization of the RADAR return, to allow unique identification of the small satellite.

There are a number of ways to integrate the Van Atta array retro-reflector into a satellite or space object. Some may be affixed directly to an external surface of the object using double-sided tape, epoxy, screws, or similar method as recognized by a person having ordinary skill in the art. Some may be integrated into solar panels or other items on the external surface of the structure.

A Van Atta array retro-reflector can be designed to modulate the returned signal, or change the spectral content or polarity of the returned signal, and this can provide a unique identification or other information about the space object to make identification easier. The RADAR return is collected by the RADAR and processed for tracking and identification purposes.

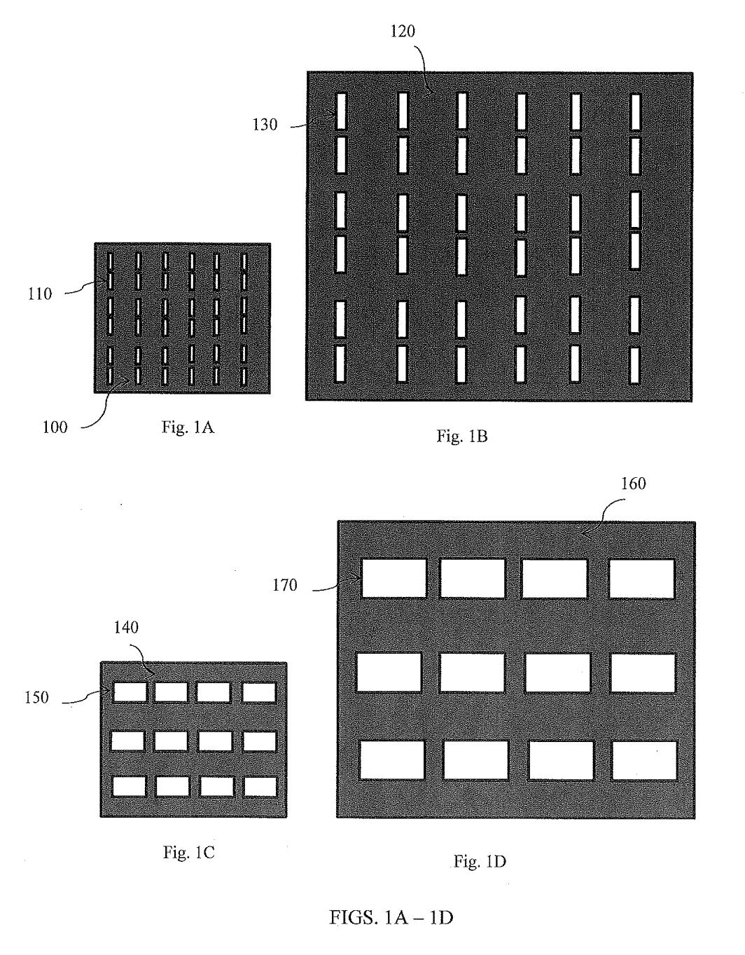

FIGS. 1A-1D are examples of retro-reflectors having various arrays of antennas. Retro-reflectors 100, 120, 140, and 160 as well as their respective antennas 110, 130, 150, and 170 can vary in size and shape depending on the type and size of satellite with which they will be coupled.

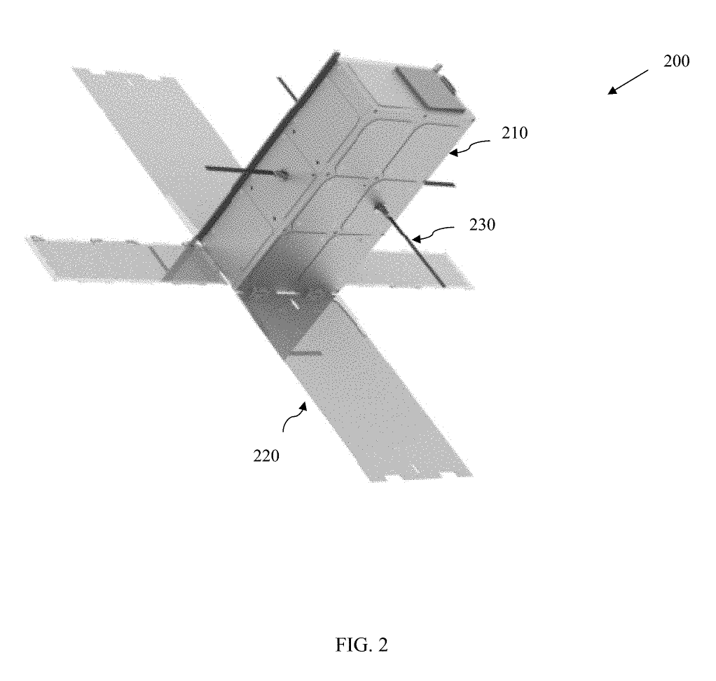

FIG. 2 shows an example of an embodiment of a satellite 200. Satellite 200 shows one embodiment of a body of a satellite 210 itself, along with solar panels 220 that are deployable and antennas 230 that are also deployable. Satellite body 210 could be a nanosatellite or a cube satellite. FIG. 2 does not show an example of a Van Atta array retro-reflector coupled to satellite 210, however at least one could be coupled to at least one side of satellite 210 as well as the underside of at least one deployable solar panel 220.

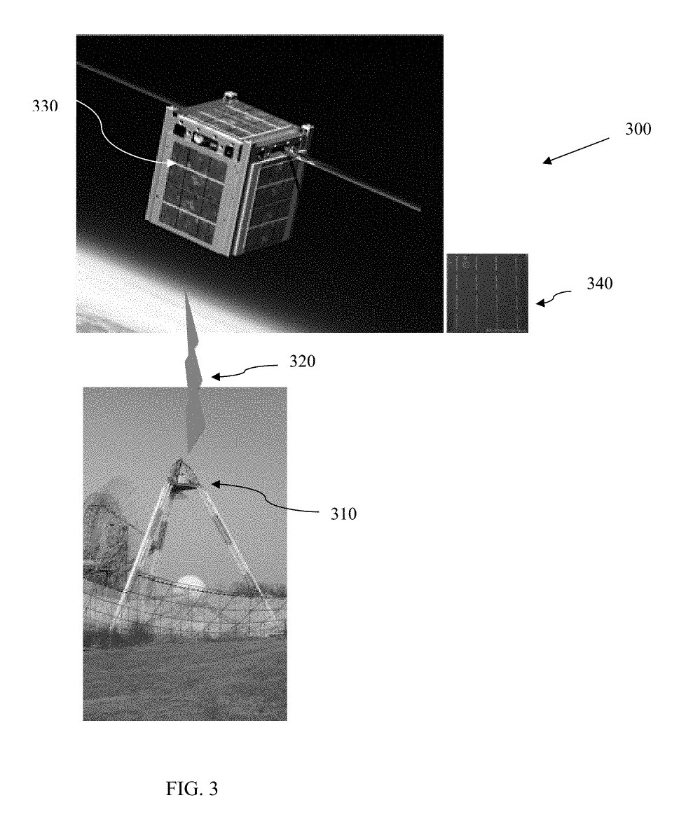

FIG. 3 shows an operational concept 300 demonstrating a RADAR system 310 sending a signal 320 to a cubesat 330 that has been launched into orbit. Cubesat 330 can have a Van Atta array retro-reflector 340 coupled to at least one of its sides. Signal 320 can have a better chance of being reflected due to retro-reflector 340, at which point a signal can be returned to RADAR system 310 to help with locating and tracking cubesat 330.

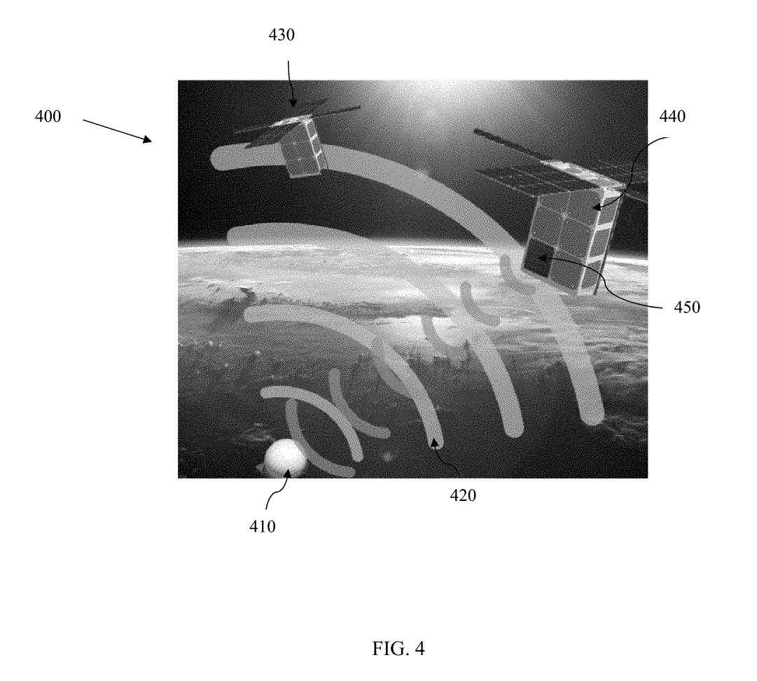

FIG. 4 shows a RADAR system 410 sending a signal 420 to a satellite 430 without an attached Van Atta array retro-reflector and to a satellite 440 with an attached Van Atta array retro-reflector 450. Van Atta array retro-reflector 450 allows for RADAR system 410 to track satellite 440. Without Van Atta array retro-reflector 450, the chances of RADAR system 410 receiving a return signal from satellite 430 are much lower.

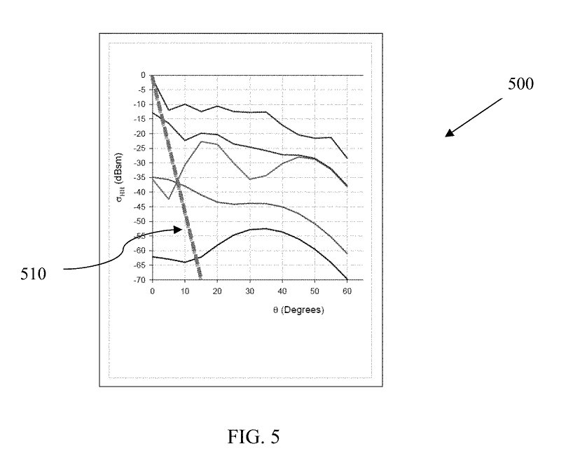

FIG. 5 shows a graph 500 of RADAR return from various experimental retro-reflectors. Dashed line 510 shows the approximate return of metal, and the solid lines represent individual retro-reflectors. The objective of the test resulting in graph 500 was to test passive retro-reflectors for better detection, tracking, and identification of nanosats for improved Space Situational Awareness. The testing helped to confirm that passive Van Atta array retro-reflectors are small enough in the Ku and X-band that they can be integrated into a cubesat.

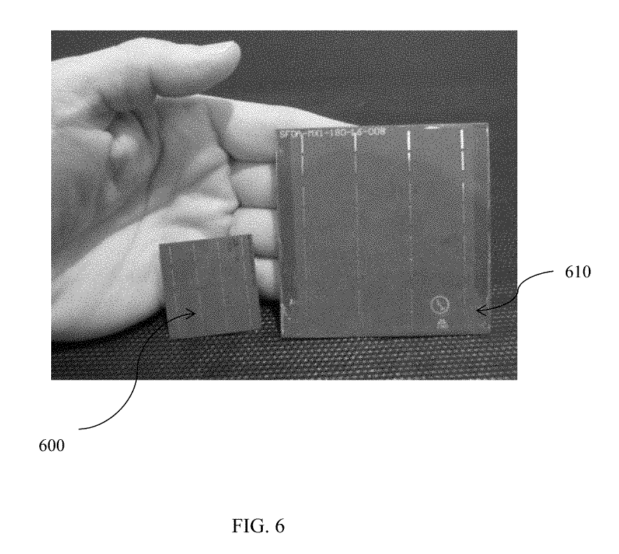

FIG. 6 shows the Van Atta array retro-reflector 600 in the Ku-band and Van Atta array retro-reflector 610 in the X-band. Retro-reflectors can be modified and integrated to fit into a nanosat or a cubesat.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method to locate and identify objects in space comprising the steps of:
selecting a specific existing RADAR system having a specific frequency, bandwidth, and polarization;
designing antennas to match the RADAR system parameters;
coupling the antennas together to form a Van Atta array retro-reflector;
identifying a satellite to be launched into space;
coupling at least one Van Atta array to the satellite;
launching the satellite;
tracking the satellite using the selected RADAR system.

2. The method of claim 1 wherein the Van Atta array retro-reflector is passive.

3. The method of claim 2 wherein the satellite is a nanosatellite (nanosat).

4. The method of claim 2 wherein the satellite is a cube satellite (cubesat).

5. The method of claim 2 wherein the satellite is a small satellite known by someone having ordinary skill in the art.

6. The method of claim 2 wherein the satellite is launched into low-earth orbit.

7. The method of claim 6 wherein the Van Atta array retro-reflector is as large as possible given the size of the satellite for optimal reflection.

8. The method of claim 7 wherein the Van Atta array retro-reflector is bolted to the satellite.

9. The method of claim 8 wherein the Van Atta array retro-reflector is coupled to the satellite using double-sided tape.

10. The method of claim 7 wherein the Van Atta array retro-reflector is coupled to the satellite using an adhesive used by someone having ordinary skill in the art.

11. The method of claim 7 further comprising the step of including modulation techniques of the return RADAR signal to support a unique nanosat identifier.

12. A system for locating and identifying objects in space comprising:
a RADAR having known parameters including frequency, bandwidth and polarization; at least one Van Atta array retro-reflector having antennas and other components that match the RADAR parameters, and a satellite.

13. The system of claim 12 wherein the Van Atta array retro-reflector is passive.

14. The system of claim 13 wherein the Van Atta array retro-reflector is coupled to the satellite.

15. The system of claim 14 wherein the satellite is a nanosatellite.

16. The system of claim 14 wherein the satellite is a cube satellite.

17. A method to track objects in space comprising the steps of:
selecting a specific existing RADAR system having desired parameters including frequency, bandwidth, and polarization;
designing antennas to match the RADAR system parameters;
coupling the antennas together to form a Van Atta array retro-reflector;
coupling at least one Van Atta array retro-reflector to at least one surface of a satellite;
deploying a solar panel on a satellite;
tracking the satellite using the selected RADAR system to illuminate the satellite and the coupled Van Atta array retro-reflectors.

18. The method of claim 17 wherein the satellite is a nanosatellite (nanosat).

19. The method of claim 18 wherein the satellite is a cube satellite (cubesat).

20. The method of claim 17 wherein at least one Van Atta array retro-reflector is also coupled to the underside of the solar panel.
